(19) United States
(12) Patent Application Publication
(10) Pub. No.: US 2004/0151449 A1
(43) Pub. Date: Aug. 5, 2004

(54) Single mode fibre

(76) Inventors: Ian Bassett, New South Wales (AU); John Canning, New South Wales (AU); Alexander Argyros, New South Wales (AU)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/472,841

(22) PCT Filed: Apr. 4, 2003
(86) PCT No.: PCT/AU02/00435

(51) Int. Cl. G02B 6/02; G02B 6/16

(52) U.S. Cl. 385/123

(57) ABSTRACT

An optical fibre (20) is disclosed, the fibre is adapted in a manner such that it guides an optical signal substantially only in one non-degenerate mode, wherein an electro-magnetic field carrying the optical signal is symmetric with respect to rotation about the fibre axis. Preferably, the non-degenerate mode is the TE01 mode. In one embodiment, the optical fibre (20) includes a central hole region (22) surrounded by a concentric guiding region (24), which is in turn surrounded by a concentric cladding region 826). The guiding region (24) may comprise a Bragg reflector region. Through appropriate selection of design parameters of the fibre (20), the effective refractive index for the TM01 mode can be reduced relative to the TE01 mode to make it below a refractive index of the cladding region (269, resulting in leaking of the TM01 mode into the cladding region (26).

### FIELD OF THE INVENTION

The present invention relates broadly to an optical fibre and to a method of fabricating an optical fibre. The invention further relates to a device and method for generating an optical signal for propagation in the optical fibre.

### BACKGROUND OF THE INVENTION

Conventional “single” mode (SM) fibres are not true single mode fibres. This is because in conventional SM fibres the supported mode is the HE11 mode. The HE11 mode is 2 fold degenerate, corresponding to the two possible polarisations of the light wave in that mode. Polarisation is a disadvantage in most applications of optical fibres, both in telecommunications and in sensing. In telecommunications, polarisation mode dispersion is one of the significant limiting factors encountered in data transmission in conventional SM fibres. In sensing employing interferometry, polarisation control must be exercised, or the sensitivity will fluctuate unpredictably, a form of “signal fading”.

Single polarisation, single mode fibres have been proposed. In such designs the single polarisation, single mode characteristic is suggested to be achieved by choosing a strong asymmetric fibre design which causes the x and y modes to behave quite differently, one remaining guided and the other becoming lossy. However, one disadvantage of such designs is that fibre orientation needs to be considered when e.g. splicing fibres together, or in forming fibre couplers or beam splitters.

In at least one of the preferred embodiments, the present invention seeks to provide a “true” single mode optical fibre for a light signal for which the modal field is substantially round, thereby e.g. eliminating the disadvantages associated with polarisation mode dispersion in data transport and signal fading in interferometry.

### SUMMARY OF THE INVENTION

In accordance with a first aspect of the present invention there is provided an optical fibre adapted in a manner such that it guides an optical signal substantially only in one non-degenerate mode, wherein an electromagnetic field carrying the optical signal is symmetric with respect to rotation about the fibre axis.

Accordingly, the present invention can provide a single mode optical fibre eliminating the disadvantages associated with polarisation mode dispersion in data transport and signal fading in interferometry, and having the advantage of not needing to consider fibre orientation when e.g. splicing fibres together or in forming fibre coupler or beam splitters.

Preferably, the non-degenerate mode is the TE01 mode.

In one embodiment, the optical fibre comprises a central hole region along its length symmetric with respect to rotation about the fibre axis, a concentric guiding region symmetric with respect to rotation about the fibre axis around the hole region, and a cladding region around the guiding region, wherein the diameter of the hole region, the thickness of the guiding region, the refractive index of the guiding region, and the refractive index of the cladding region are chosen such that, in use, only the one non-degenerate mode is guided in the guiding region.

Preferably, the diameter of the hole region, the thickness of the guiding region, the refractive index of the guiding region, and the refractive index of the cladding region are chosen such that, in use, an effective refractive index for the HE11 mode of the optical signal is reduced to be equal to or below the refractive index of the cladding region, whereby the HE11 mode is radiated away from the guiding region.

The refractive index of the guiding region and/or the cladding region may be graded.

In an alternative embodiment, the optical fibre comprises a concentric Bragg reflector region symmetric with respect to rotation about the fibre axis around a guiding region symmetric with respect to rotation about the fibre axis, wherein the Bragg reflector region is arranged in a manner such that, in use, least leaking into the cladding region is experienced by the TE01 mode, whereby substantially only the TE01 mode is guided in the guiding region.

The optical fibre in such an embodiment may comprise a photonic crystal fibre.

The optical fibre in such an embodiment may further comprise a central hole region symmetric with respect to rotation about the fibre axis arranged in a manner such that an effective refractive index for the HE11 mode of the optical signal is reduced to be equal to or below the refractive index of the cladding region, whereby the HE11 mode is radiated away from the guiding region to assist suppressing guiding of the HE11 mode in the guiding region.

In yet another alternative embodiment, the optical fibre may comprise absorption means adapted to preferentially absorb light in modes other than the one non-degenerate mode. The optical fibre in such an embodiment may further comprise amplifying means adapted to amplify substantially only the one non-degenerate mode. The absorption means and/or the amplification means may comprise regions of the optical fibre made from a suitable optically absorbing or amplifying material respectively.

In accordance with a second aspect of the present invention there is provided a method of manufacturing an optical fibre, the method comprising the step of selecting design parameters in the manufacture of the optical fibre in a manner such that the optical fibre guides an optical signal only in one non-degenerate mode, wherein an electro-magnetic field carrying the optical signal is symmetric with respect to rotation about the fibre axis.

Preferably, the non-degenerate mode is the TE01 mode.

In one embodiment, the method comprises the step of selecting the diameter of a central hole region symmetric with respect to rotation about the fibre axis, the thickness of a concentric guiding region symmetric with respect to rotation about the fibre axis around the hole region, the refractive index of the guiding region, and the refractive index of a cladding region of the fibre around the guiding region such that, in use, only the one non-degenerate mode is guided in the guiding region.

Preferably, the diameter of the hole region, the thickness of the guiding region, the refractive index of the guiding region, and the refractive index of the cladding region are selected such that, in use, an effective refractive index for the HE11 mode of the optical signal is reduced to be equal to or below the refractive index of the cladding region, whereby the HE11 mode is radiated away from the guiding region.

The refractive index of the guiding region and/or the cladding region may be graded.

In an alternative embodiment, the method comprises the steps of selecting a Bragg reflector region symmetric with respect to rotation about the fibre axis around a guiding region symmetric with respect to rotation about the fibre axis and arranged in a manner such that, in use, least leaking into a cladding region of the fibre around the Bragg region is experienced, in use, by the TE01 mode, whereby substantially only the TE01 mode is guided in the guiding region.

The optical fibre in such an embodiment may comprise a photonic crystal fibre.

The method in such an embodiment may further comprise the step of forming a central hole region in the optical fibre symmetric with respect to rotation about the fibre axis and arranged in a manner such that an effective refractive index for the HE11 mode of the optical signal is reduced to be equal to or below the refractive index of the cladding, whereby the HE11 mode is radiated away from the guiding region to assist suppressing guiding of the HE11 mode in the guiding region.

The method in yet another alternative embodiment may comprise the steps of providing absorption means associated with the optical fibre and adapted to preferentially absorb light in modes other than the one non-degenerate mode. The method in such an embodiment may further comprise the step of providing amplifying means associated with the optical fibre and adapted to amplify substantially only the one non-degenerate mode. The absorption means and/or the amplification means may comprise regions of the optical fibre made from a suitable optically absorbing or amplifying material respectively.

In accordance with a third aspect of the present invention there is provided a light source structure adapted in a manner such that it generates a light signal which comprises substantially only one non-degenerate mode, wherein a modal field of the light signal is substantially round.

Preferably, the light source structure comprises an optical fibre laser, wherein the optical fibre laser comprises an optical fibre as defined in the first aspect of the present invention.

In accordance with a fourth aspect of the present invention there is provided a method of generating a light signal which comprises substantially only one non-degenerate mode, and wherein a modal field of the light signal is substantially round.

Preferably, the method comprises the step of effecting lasing to occur in an optical light source structure as defined in the third aspect of the present invention.

### BRIEF DESCRIPTION OF THE DRAWINGS

Preferred forms of the present invention will now be described, by way of example only, with reference to the accompanying drawings.

FIG. 1 shows a plot of the intensity of different modes of propagation of an optical signal travelling in a typical radially symmetric waveguide as a function of radius r.

FIG. 2 is a schematic cross sectional view of an optical fibre embodying the present invention.

FIG. 3 is a schematic cross sectional view of another optical fibre embodying the present invention.

FIG. 4 is a schematic cross sectional view of another optical fibre embodying the present invention.

FIG. 5 is a schematic cross sectional view of another optical fibre embodying the present invention.

FIGS. 6(A), (B) & (C) are schematic diagrams illustrating a manufacturing process for an optical fibre embodying the present invention.

FIG. 7 is a schematic diagram illustrating an optical fibre laser arrangement embodying the present invention.

### DETAILED DESCRIPTION OF THE EMBODIMENTS

The preferred embodiments described provide an optical fibre adapted in a manner such that it guides an optical signal substantially only one non-degenerate mode, and wherein a modal field of the guided light signal is substantially round. The preferred embodiments described have the advantage that there is no need to select the fibre orientation in splicing fibres together, or forming structures such as fibre couplers or beam splitters.

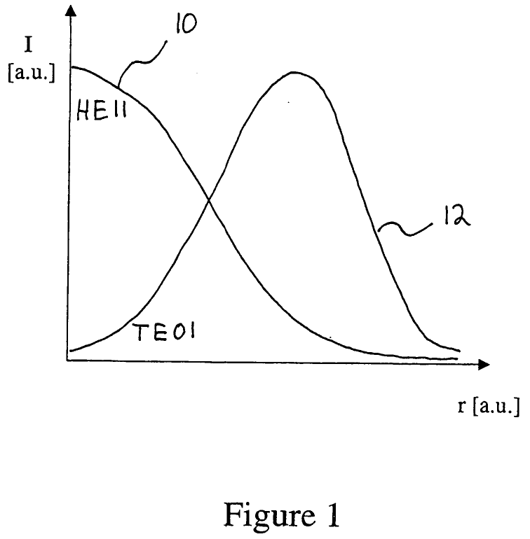

FIG. 1 shows a plot of the intensity of different modes of propagation of an optical signal travelling in a radially symmetric waveguide as the function of the radius r. As can be seen from FIG. 1 the intensity curve for the highest mode HE11, curve 10, has a maximum at the centre of the waveguide. In contrast, the curve for what is normally the next lower mode, the TE01 mode, curve 12, has its maximum intensity in a doughnut shaped maximum around the centre of the waveguide. Importantly, the TE01 mode is a non-degenerate mode. That is, in this mode the magnetic quantum number m=0. Thus a light signal that propagates only in e.g. the TE01 mode will not experience polarisation mode dispersion or interferometric signal fading resulting from superposition of polarisations.

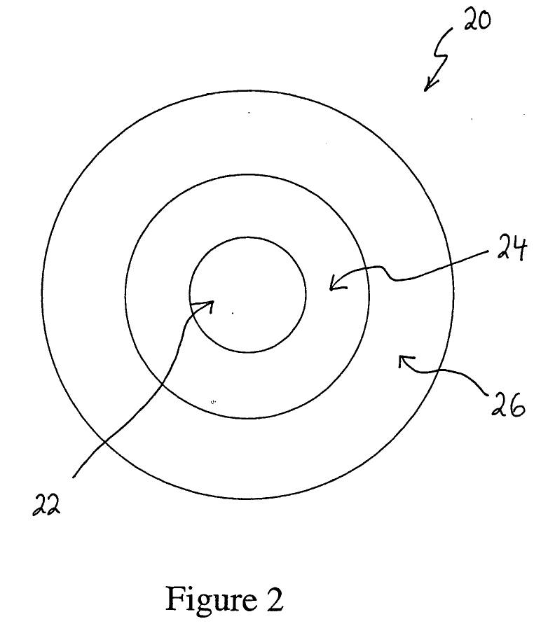

In one embodiment of the present invention illustrated in FIG. 2, an optical fibre 20 is designed having the following characteristics. It comprises a central hole region 22, surrounded by a concentric guiding region 24, which is in turn surrounded by a concentric cladding region 26.

It is the design object in the optical fibre 20 to chose the design parameters in a manner such that the effective refractive index for the HE11 mode is reduced due to the presence of the hole region 22 to a value equal to or below the refractive index of the cladding region 26. If this design condition is achieved, the HE11 mode will be leaking from the guiding region 24 through the cladding region 26, i.e. its guided propagation along the guiding region 24 of the optical fibre 20 is suppressed.

It will be appreciated by a person skilled in the art, that through appropriate selection of the design parameters of the optical fibre 20, the presence of the hole region 22 will not significantly perturb the TE01 mode (compare FIG. 2) thus leaving the TE01 mode as the mode with the now highest effective refractive index experienced by any mode. Through suitable selection of the design parameters of the optical fibre 20 in the exemplary embodiment such that the effective refractive index experienced by all other (lower) modes will be equal to or lower than the refractive index of the cladding region 26, those modes will also leak from the guiding region 24.

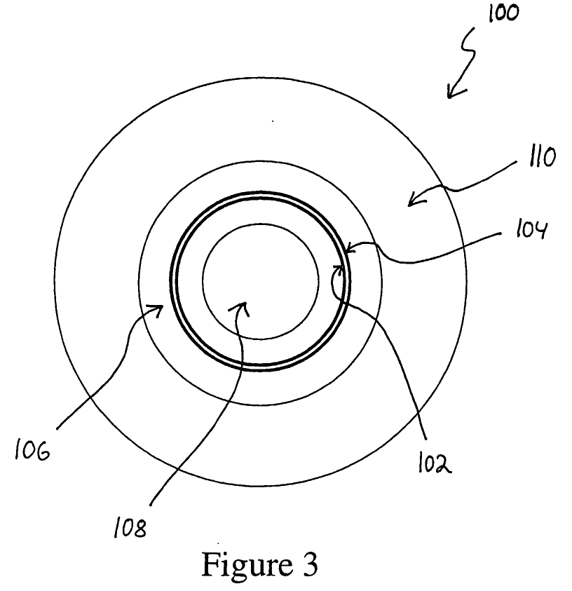

Depending on the material and/or wavelength of a light signal of interest, the effective refractive index for the TM01 mode can be close to the effective refractive index for the TE01 mode. It may then be advantageous to provide a further means for assisting the suppression of light propagation in the TM01 mode. In another optical fibre design 100 embodying the present invention shown in FIG. 3, closely spaced concentric rings e.g. 102, 104 of alternating refractive index are placed within a concentric guiding region 106 roughly where the TE01 mode (and the TM01 mode) has a maximum intensity (compare FIG. 1). The fibre design 100 further comprises a central hole region 108 and a concentric cladding region 110.

In the fibre design 100, the concentric rings e.g. 102, 104 of alternating refractive index is expected, in an example embodiment, to alter the effective refractive index for the TE01 mode more than for the TM01 mode. Through appropriate selection of the design parameters, the effective refractive index for the TM01 mode can be reduced relative to the TE01 mode to assist in ensuring that it is equal to or below the refractive index of the cladding region 110, which in turn ensures that the TM01 mode experiences leaking into the cladding region 110.

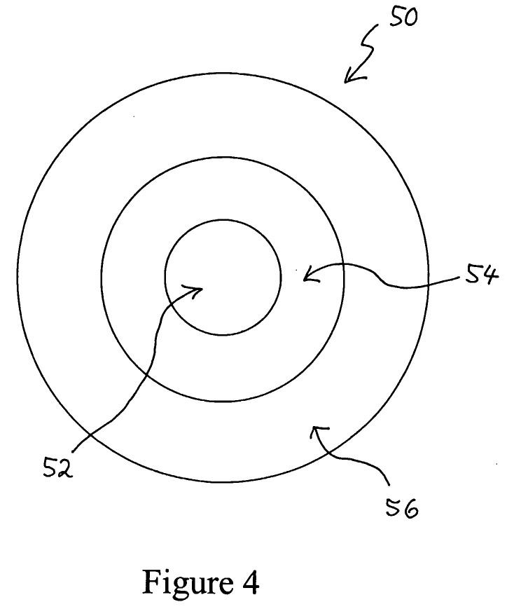

In yet another embodiment of the present invention shown in FIG. 4, an optical fibre 50 comprises a cylindrical centre region 52 surrounded by a concentric guiding region 54, which in turn is surrounded by a concentric cladding region 56.

The material of which the central region 52 is formed is chosen such that it absorbs light at the wavelength of a particular light signal intended for propagation in the guiding region 54.

It will be appreciated by the person skilled in the art that, since the HE11 mode has a maximum in its intensity at the centre of the optical fibre 50 (compare FIG. 1), this will result in preferential absorption of the HE11 mode. This is in contrast with the situation for the TE01 mode (compare FIG. 1), which will experience an insignificant perturbance caused by the absorption in the centre region 52, provided that the design parameters of the optical fibre 50 are chosen appropriately.

In a modification of the optical fibre 50 shown in FIG. 4, the material of the guiding region 54 may further be chosen in a manner such that it amplifies light at the wavelength of the particular light signal, which will in effect result in preferential amplification of the TE01 mode, which has a doughnut shape maximum in its intensity in the area of the guiding region 54 (compare FIG. 1) if the design parameters chosen appropriately. This can enhance the true single mode characteristics of an optical fibre embodying the present invention.

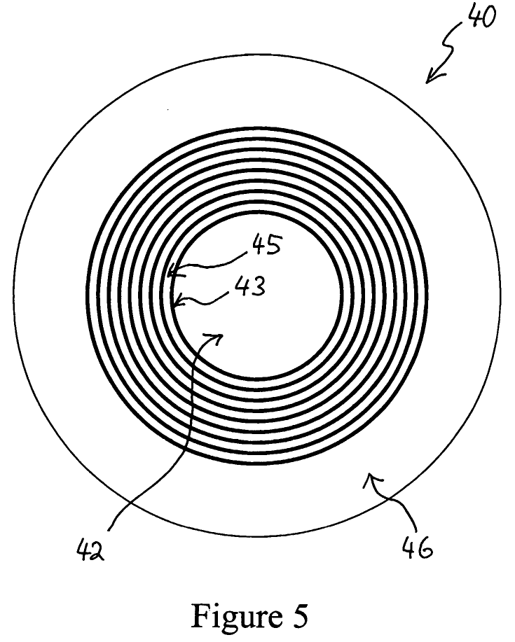

In a preferred embodiment of the present invention shown in FIG. 5, an optical fibre 40 comprises a core region 42, surrounded by a concentric Bragg reflector region 44, which in turn is surrounded by a concentric cladding region 46. The Bragg reflector region 44 comprises a refractive index profile, in an exemplary embodiment symmetric with respect to rotation about the fibre axis, which constitutes a grating structure with respects to a light signal propagated within the core region 42.

In the preferred embodiment, the set of concentric Bragg reflecting layers of successive higher and lower refractive index, e.g. 43, 45 can be made more effective in the preferential guidance of the TE polarised modes by choosing its parameters so that its reflectivity is polarisation dependent. The phenomena connected with the Brewster angle in a planar stack of layers of alternating refractive index n₁ and n₂ has been found to have an analogue for a similar concentric stack in the Bragg fibre 40. For a given wavelength and alternating indices n₁ and n₂ the effective refractive index of the best guided mode can be adjusted quite freely by varying the thickness of the layers e.g. 43, 45 (and so the Bragg condition) and the size of the core 42. The Brewster condition for a planar stack coincides with that for a Bragg fibre at large radius and may be written n_{eff}=n₁n₂/\sqrt{n₁²+n₂²}, where n_{eff} is the effective refractive index at the given wavelength. For values of n_{eff} in a Bragg fibre close to meeting this Brewster condition, i.e. embodying the present invention, Bragg reflection is undermined for TM modes and also for hybrid modes, which have a component of TM polarisation.

It has been found by the applicant that in the optical fibres of the design of optical fibre 40 shown in FIG. 5, the least leaking of light intensity occurs for the TE01 mode. In other words, the optical fibre 40 of the preferred embodiment will preferentially guide light only in the TE01 mode, whilst suppressing the guiding of any of the other modes. It will be appreciated that for the fibre to be effectively single moded, there must be a sufficient difference between the losses of the best guided mode and of the other modes. At the same time, the loss of the best guided mode should be low enough that the fibre can be used for transmission. These considerations lead to the concept of a length Lₛₘ beyond which the fibre is effectively single moded, and a maximum useful length Lₘₐₓ.

Table I shows results of calculations conducted on an example design of optical fibre 40. In that example design, an air core region 42 (refractive index n=1) of radius 1.828 μm, and 16 pairs of high and low refractive index layers e.g. 43, 45 respectively where considered. The refractive index of the high index layer e.g. 43 is 1.49, thickness 0.2133 μm, and the refractive index of the lower index layer e.g. 45 is 1.17, thickness 0.346 μm.

Table I displays the loss in dB/m for each mode. The second last column shows the length in metres L_{1%,} at which the transmitted power in that mode is reduced to 1%. The last column is the length L_{0.01%}=2 L_{1%,} at which the power in that mode is reduced to 0.01%. From the figures in the last two columns it can be illustrated in the example embodiment at what minimum length (Lₛₘ=L_{0.01%} for second best guided mode) the fibre is effectively single moded, and what the maximum useful length is (Lₘₐₓ=L_{1%} for best guided mode). In other words, for illustrative purposes the example fibre is substantially single moded for length greater than about Lₛₘ=2 cm, and is usefully transmissive up to a length of Lₘₐₓ=400 m. Whilst for this illustration only the second best guided mode was taken into account in determining the onset of single modedness, it will be appreciated that it does not make much difference if other modes of lower loss are also taken into account. Modes omitted from Table I are lossier than those shown. Furthermore, it will be appreciated that the results shown in Table I are illustrative only of an example embodiment of the present invention, and that the present invention is not limited to such a design.

TABLE I

| mode | | | | | | |
|---|---|---|---|---|---|---|
| class | | effective index (β/k) | | | | |
| m* | | real | imaginary | loss (dB/m) | L_{1%} m (20 dB) | L_{0.01%} m (40 dB) |
| 0 | TE | 0.941762 | 9.2086 × 10⁻¹⁰ | 5.026 × 10⁻² | 398 | 796 |
| 0 | TE | 0.812685 | 3.1489 × 10⁻⁵ | 1.719 × 10³ | 1.16 × 10⁻² | 2.33 × 10⁻² |
| 1 | hybrid | 0.888962 | 1.3357 × 10⁻³ | 7.290 × 10⁴ | 2.74 × 10⁻⁴ | 5.49 × 10⁻⁴ |
| 0 | TE | 0.789125 | 2.278 × 10⁻³ | 1.243 × 10⁵ | 1.61 × 10⁻⁴ | 3.22 × 10⁻⁴ |
| 1 | hybrid | 0.977576 | 2.408 × 10⁻³ | 1.314 × 10⁵ | 1.52 × 10⁻⁴ | 3.04 × 10⁻⁴ |
| 2 | hybrid | 0.82833 | 2.957 × 10⁻³ | 1.614 × 10⁵ | 1.24 × 10⁻⁴ | 2.48 × 10⁻⁴ |
| 3 | hybrid | 0.765984 | 5.137 × 10⁻³ | 2.804 × 10⁵ | 7.13 × 10⁻⁵ | 1.43 × 10⁻⁴ |

*The azimuthal field dependence is exp(±imφ)

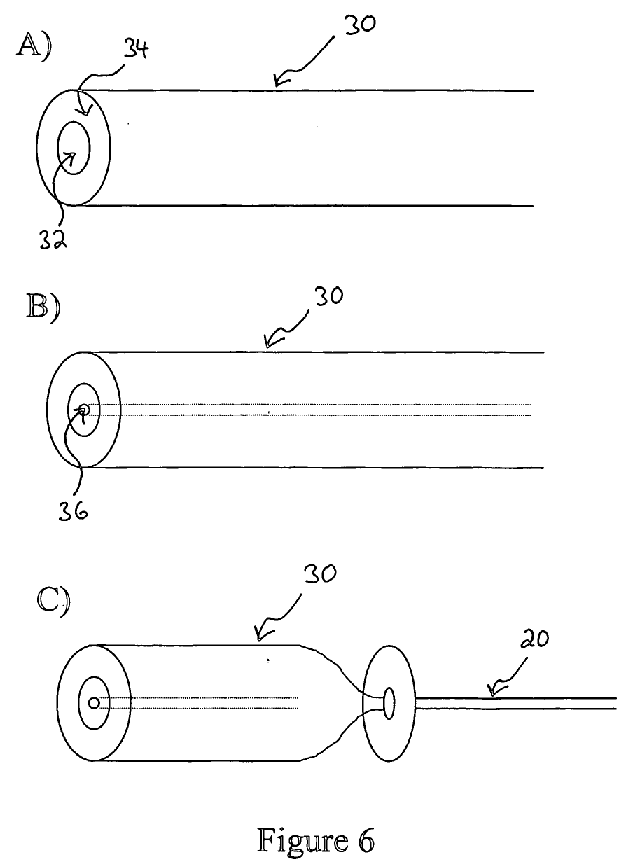

It will be appreciated by a person skilled in the art that the optical fibres of the exemplary embodiments can be manufactured utilising existing optical fibre manufacturing techniques. One exemplary method of manufacturing the optical fibre 20 (see FIG. 2) embodying the present invention will now be described briefly with reference to FIG. 6. In FIG. 6A, as a first step a preform 30 is manufactured utilising known techniques such as modified chemical vapour deposition (MCVD) inside a tubular carrier member (not shown). The preform 30 has a step function in its refractive index i.e. it consists on a core region 32 and a cladding region 34 of differing refractive index.

As shown in FIG. 6B, in a next step a hole 36 is created in the preform 30 through e.g. drilling.

In a final step shown in FIG. 6C, an optical fibre 38 is drawn from the preform 30. It will be appreciated by a person skilled in the art that the design parameters of the preform 30 can be selected such that they correspond to the desired design characteristics of the optical fibre 20.

In an alternative embodiment, a method of manufacturing an optical fibre of the type of optical fibre 40 (see FIG. 5) comprises utilising glass for the high index rings and glass with holes for the lower index rings and core, to achieve a desired refractive index contrast. Such structures form a sub-set of what are referred to as “photonic crystal” or “holey” fibres.

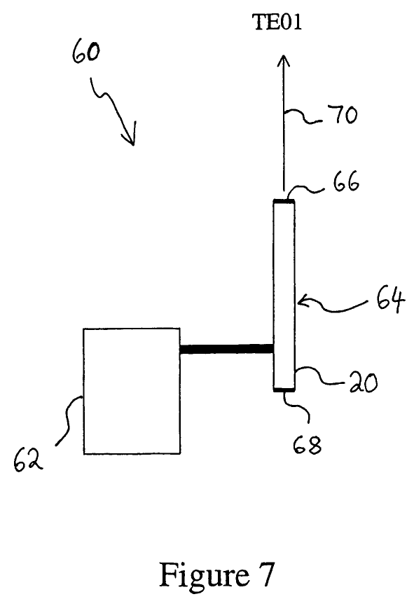

FIG. 7 shows an optical fibre laser signal arrangement 60 embodying the present invention. The optical fibre laser arrangement 60 comprises a pump laser source 62 for pumping an optical fibre laser 64. Importantly, the optical fibre laser 64 comprises an optical fibre embodying the present invention, in the exemplary embodiment an optical fibre of the type of optical fibre 40 described above with reference to FIG. 5.

It will be appreciated by the person skilled that to construct the fibre laser 64 utilising an optical fibre of the type of optical fibre 20, e.g. a suitable dopant material is provided in the guiding region 24 (see FIG. 2) to effect lasing between reflective elements 66, 68 at end portions of the optical fibre laser 64. One of the reflective elements 66 is e.g., a semi-transparent reflective element, thus enabling emission of the TE01 laser beam 70.

It will be appreciated by a person skilled in the art that the optical fibre laser arrangement 60 is suitable for substantially direct coupling of light into optical fibre embodying the present invention, e.g., optical fibre of the type of optical fibre 20, optical fibre 100, or optical fibre 50 described above with reference to FIG. 2, FIG. 3, and FIG. 6 respectively.

It will be appreciated by the person skilled in the art that numerous modification and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. An optical fibre adapted in a manner such that it guides an optical signal substantially only in one non-degenerate mode, wherein an electromagnetic field carrying the optical signal is symmetric with respect to rotation about the fibre axis.

2. An optical fibre as claimed in claim 1, wherein the non-degenerate mode is the TE01 mode.

3. An optical fibre as claimed in claim 1, wherein the optical fibre comprises:
a central hole region along its length symmetric with respect to rotation about the fibre axis,
a concentric guiding region symmetric with respect to rotation about the fibre axis around the hole region, and
a cladding region around the guiding region,
wherein the diameter of the hole region, the thickness of the guiding region, the refractive index of the guiding region, and the refractive index of the cladding region are chosen such that, in use, only the one non-degenerate mode is guided in the guiding region.

4. An optical fibre as claimed in claim 3, wherein the diameter of the hole region, the thickness of the guiding region, the refractive index of the guiding region, and the refractive index of the cladding region are chosen such that, in use, an effective refractive index for the HE11 mode of the optical signal is reduced to be equal to or below the refractive index of the cladding region, whereby the HE11 mode is radiated away from the guiding region.

5. An optical fibre as claimed in claim 3, wherein the refractive index of the guiding region and/or the cladding region is graded.

6. An optical fibre as claimed in claim 1, wherein the optical fibre comprises:
a concentric Bragg reflector region symmetric with respect to rotation about the fibre axis around a guiding region symmetric with respect to rotation about the fibre axis,
wherein the Bragg reflector region is arranged in a manner such that, in use, least leaking into the cladding region is experienced by the TE01 mode, whereby substantially only the TE01 mode is guided in the guiding region.

7. An optical fibre as claimed in claim 6, wherein the optical fibre comprises a photonic crystal fibre.

8. An optical fibre as claimed in claim 6, wherein the optical fibre further comprises a central hole region symmetric with respect to rotation about the fibre axis arranged in a manner such that an effective refractive index for the HE11 mode of the optical signal is reduced to be equal to or below the refractive index of the cladding region, whereby the HE11 mode is radiated away from the guiding region to assist suppressing guiding of the HE11 mode in the guiding region.

9. An optical fibre as claimed in claim 1, wherein the optical fibre comprises:
absorption means adapted to preferentially absorb light in modes other than the one non-degenerate mode.

10. An optical fibre as claimed in claim 9, wherein the optical fibre further comprises amplifying means adapted to amplify substantially only the one non-degenerate mode.

11. An optical fibre as claimed in claim 9, wherein the absorption means and/or an amplification means comprise regions of the optical fibre made from a suitable optically absorbing or amplifying material respectively.

12. A method of manufacturing an optical fibre, the method comprising the step of selecting design parameters in the manufacture of the optical fibre in a manner such that the optical fibre guides an optical signal substantially only in one non-degenerate mode, wherein an electromagnetic field carrying the optical signal is symmetric with respect to rotation about the fibre axis.

13. A method as claimed in claim 12, wherein the non-degenerate mode is the TE01 mode.

14. A method as claimed in claim 12, wherein the method comprises the step of:
selecting the diameter of a central hole region symmetric with respect to rotation about the fibre axis, the thickness of a concentric guiding region symmetric with respect to rotation about the fibre axis around the hole region, the refractive index of the guiding region, and the refractive index of a cladding region of the fibre around the guiding region such that, in use, only the one non-degenerate mode is guided in the guiding region.

15. A method as claimed in claim 14, the diameter of the hole region, the thickness of the guiding region, the refractive index of the guiding region, and the refractive index of the cladding region are selected such that, in use, an effective refractive index for the HE11 mode of the optical signal is reduced to be equal to or below the refractive index of the cladding region, whereby the HE11 mode is radiated away from the guiding region.

16. A method as claimed in claim 14, wherein the refractive index of the guiding region and/or the cladding region is graded.

17. A method as claimed in claim 12, wherein the method comprises the steps of:
selecting a Bragg reflector region symmetric with respect to rotation about the fibre axis around a guiding region symmetric with respect to rotation about the fibre axis and arranged in a manner such that, in use, least leaking into a cladding region of the fibre around the Bragg region is experienced, in use, by the TE01 mode, whereby substantially only the TE01 mode is guided in the guiding region.

18. A method as claimed in claim 17, wherein the optical fibre comprises a photonic crystal fibre.

19. A method as claimed in claim 17, wherein the method further comprises the step of:
forming a central hole region symmetric with respect to rotation about the fibre axis in the optical fibre and arranged in a manner such that an effective refractive index for the HE11 mode of the optical signal is reduced to be equal to or below the refractive index of the cladding, whereby the HE11 mode is radiated away from the guiding region to assist suppressing guiding of the HE11 mode in the guiding region.

20. A method as claimed in claim 12, wherein the method comprises the steps of providing absorption means associated with the optical fibre and adapted to preferentially absorb light in modes other than the one non-degenerate mode.

21. A method as claimed in claim 20, wherein the method further comprises the step of providing amplifying means associated with the optical fibre and adapted to amplify substantially only the one non-degenerate mode.

22. A method as claimed in claim 20, wherein the absorption means and/or an amplification means comprise regions of the optical fibre made from a suitable optically absorbing or amplifying material respectively.

23. A light source structure adapted in a manner such that it generates a light signal which comprises substantially only one non-degenerate mode, wherein a modal field of the light signal is substantially round.

24. A light source structure as claimed in claim 23, wherein the light source structure comprises an optical fibre laser, and wherein the optical fibre laser comprises an optical fibre as defined in any one of claims 1 to 11.

25. A method of generating a light signal which comprises substantially only one non-degenerate mode, wherein a modal field of the light signal is substantially round.

26. A method as claimed in claim 25, wherein the method comprises the step of effecting lasing to occur in an optical light source structure as defined in claims 23 or 24.
